(19) United States
(12) Patent Application Publication
(10) Pub. No.: US 2005/0209853 A1
(43) Pub. Date: Sep. 22, 2005

(54) Speech disambiguation for string processing in an interactive voice response system

(75) Inventors: Brent L. Davis, Deerfield Beach, FL (US); Alan P. McDonley, Boynton Beach, FL (US); Vanessa V. Michelini, Boca Raton, FL (US); Peeyush Jaiswal, Boca Raton, FL (US)

Correspondence Address: CHRISTOPHER & WEISBERG, PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/804,688

(22) Filed: Mar. 19, 2004

(51) Int. Cl. G10L 15/00

(52) U.S. Cl. 704/249

(57) ABSTRACT

A method, system and apparatus for processing string input for a field in a voice enabled application executing within an IVR system. The method can include identifying a sub-string pattern of characters within acceptable input for the field which is known to enjoy a high likelihood of recognition, and prompting an interacting user for string input limited to the sub-string pattern. Received sub-string input conforming to the sub-string pattern can be matched with data which conforms to the acceptable input to locate the string input for the field. Consequently, the field can be completed with the matched data.

### BACKGROUND OF THE INVENTION

1. Statement of the Technical Field

The present invention relates to the field of interactive voice response systems and more particularly to field recognition in an interactive voice response system.

2. Description of the Related Art

Interactive voice response (IVR) systems perform a critical role in the customer service industry by providing an essential reduction in operating costs in terms of avoiding the use of expensive human capital in processing incoming telephone calls. Generally, IVR systems include speech recognition and text-to-speech processing capabilities coupled to a script defining a call flow. Consequently, IVR systems can be utilized to provide a voice interactive experience for callers just as if a live human had answered and processed the telephone call.

IVR systems have proven particularly useful in adapting Web based information systems to the audible world of voice processing. While Web based information systems have been particularly effective in collecting and processing information from end users through the completion of fields in an on-line form, the same also can be said of IVR systems. In particular, Voice XML and equivalent technologies have provided a foundation upon which Web forms have been adapted to voice. Consequently, IVR systems have been configured to undertake complex data processing Through forms based input just as would be the case through a conventional Web interface.

Often, forms based processing can involve data lookups based upon information provided in one or more fields of an on-line form. Examples include query building and the auto-completion of a field in the form. While providing complex data input such as alphanumeric input through a visual interface can be of no consequence, the same cannot be said of the voice interface of an IVR systems. Rather, challenges in handling low-recognition rate characters can impede the processing of an input field in a for adapted for voice processing.

In many cases, IVR systems can avoid the use of voice processing and speech recognition technologies by permitting DTMF based input. Yet, even where DTMF based input can be used to provide input to a field in an IVR system, the limited number of keys in a telephone keypad inherently can provide ambiguities in the processing of DMRD input. Specifically, any one key on the keypad can represent up to three or four different letters or numbers. As a result, one or more disambiguation processes can be required to determine the desired input for a field. Disambiguation processes though helpful, can be cumbersome where overused. Accordingly, a minimal number of disambiguation cycles will be preferred in the course of handling field input in an IVR system.

### SUMMARY OF THE INVENTION

The present invention addresses the deficiencies of the art in respect to the speech disambiguation for string processing in an IVR system and provides a novel and non-obvious method, system and apparatus for processing string input for a field in an IVR system. The method can include identifying a sub-string pattern of characters within acceptable input for the field which is known to enjoy a high likelihood of recognition, and prompting an interacting user for string input limited to the sub-string pattern. Received sub-string input conforming to the sub-string pattern can be matched with data which conforms to the acceptable input to locate the string input for the field. Consequently, the field can be completed with the matched data.

The identifying step can include the step of identifying a sub-string pattern of characters within acceptable input for the field which is known to enjoy both a high likelihood of recognition and a high level of uniqueness. Also, the identifying step can include the step of identifying a sub-string pattern of numeric, alphabetic and alphanumeric characters within acceptable input for the field which is known to enjoy a high likelihood of recognition. In this regard, the method further can include the step of pre-specifying which characters have a high likelihood of recognition. For instance, the method further can include the step of pre-specifying a likelihood of recognition value for each of the characters.

The matching step can include the step of querying a database for all records which have a specified field which contains the received sub-string input. If the matching step produces a set of matching data where each data item in the set matches the sub-string input, a desired data item can be disambiguated from other data items in the set. As an example, the disambiguating step can include selecting an additional field for processing and additionally prompting the interacting user for additional input for the additional field. Once received, additional input to the additional prompting can be matched with data which conforms to the acceptable input to locate the string input for the field.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following Detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an IVR system configured for the speech disambiguation of strings in accordance with the inventive arrangements; and,

FIG. 2 is a flow chart illustrating a process for speech disambiguation of strings in the IVR system of FIG. 1.

### DETAILED DESCRIPTION OF THE PREFERRED EMBODIMENTS

The present invention is a method, system and apparatus for the speech disambiguation of strings in an IVR system. In accordance with the present invention, one or more fields within an interface managed by the IVR system can be processed to identify a subset of input for the field which enjoys a higher likelihood of pattern recognition. Specifically, the string can be inspected to identify a subset consisting of numbers, letters or both which enjoys a higher likelihood of accurate speech recognition than other numeric characters, alphabetic characters, and alphanumeric characters in the string. Similarly, the string can be inspected to identify a pattern of numeric characters, alphabetic characters, and alphanumeric characters which are more likely to be uniquely identified among a database of strings than other numeric characters, alphabetic characters, and alphanumeric characters.

Once a subset has been identified for the strings associated with the field, interacting users can be prompted to complete the field not by specification of the entire string associated with the field, but with a mere subset of the string associated with the field. As the subset will have been chosen to enhance both the likelihood of speech recognition and unique identification, the IVR system can more efficiently match the provided input to existing data for the field without requiring the use of exhaustive levels of prompting for complete string input. In this regard, the provided user input can be disambiguated from other possible matching data without subjecting the user to unnecessary prompts.

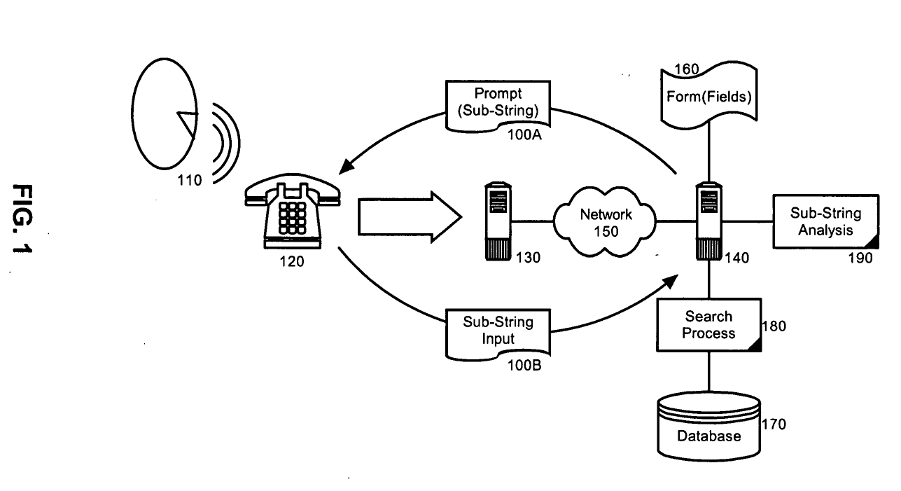

FIG. 1 is a schematic illustration of an IVR system 140 configured for the speech disambiguation of strings in accordance with the inventive arrangements. The IVR system 140 can be coupled to a computer communications network 150 over which one or more end users 110 can access the IVR system 140. The IVR system 140 particularly can be coupled to a call processing gateway 130 through which the end users 110 can access the IVR system 140 through a telephony user interface 120. In particular, the telephony user interface 120 can provide telephonic means by which the end users 110 can access the IVR system 140, such as through voice prompting and speech recognition, or DTMF signaling and DTMF signal processing.

The IVR system 140 also can be coupled to an IVR application (not shown) having one or more forms such as VoiceXML defined forms (not shown) having one or more form fields 160 (only one form field shown for the purpose of illustrative simplicity). The form field 160 can be used to indicate that the end users 110 are to provide user input to complete the form field 160. To that end, the skilled artisan will recognize that the form field 160 can be freely completed without validation, or the input provided to complete the form field 160 can be limited to data pre-existing in a database 170. Thus, the IVR system 140 can further be coupled to a search process 180 with which the database 170 can be searched based upon input to the form field 160.

In accordance with the present invention, the IVR system 140 can be configured with a sub-string analyzer 190. The sub-string analyzer 190 can be programmed to inspect individual numeric, alpha, and alphanumeric characters of a string field in the database 170. The sub-string analyzer 190 further can be programmed to compute a likelihood of uniqueness and recognition of each position in the string for the entries in the database 170 to determine a sub-string pattern of characters having a highest likelihood both of recognition and uniqueness.

For example, the database 190 can be a contact database incorporating the name, address, telephone number and order number of a series of customers as follows:

| | | | |
|---|---|---|---|
| John Smith | 123 Elm Street | 561-123-4567 | S1234JW3457 |
| Bob Johnson | 456 Oak Lane | 954-456-7890 | J4987HQ4539 |
| Jane Doe | 789 Wood Ave | 305-987-6543 | D8764L7795 |
| John Doe | 789 Wood Ave | 305-987-6543 | D9764L7795 |

The order number field can be associated with the form field 160 for order number. Instead of requiring the end users 110 to specify the entire order number, however, a sub-string within the order number field can be identified as the last four digits which enjoy a high probability of recognition and uniqueness.

In operation, once the suitable sub-string has been identified by the sub-string analyzer 190, the IVR system 140 can accept forms interaction from the end users 110. In particular, when the form field 160 has been activated, the IVR system 140 can forward a prompt 100A for the end users 110 to provide input not for the entire string associated with the form field 160, but for the sub-string identified by the sub-string analyzer 190. The end users 110, in turn, can provide sub-string input 110B to the IVR system 140.

The IVR system 140 can use the searching facility 180 to query the database 170 based upon the sub-string input 100B and not based upon the entirety of the string associated with the form field 160. The searching facility 180 can return zero or more matching strings. To the extent that a single matching string can be identified for the sub-string input 100B, the form field 160 can be completed with the unique matching string. In the event, however, that multiple matching strings are returned by the searching facility 180, one or more additional disambiguating prompts can be provided to determine which of the strings are to be selected for completion of the form field 160.

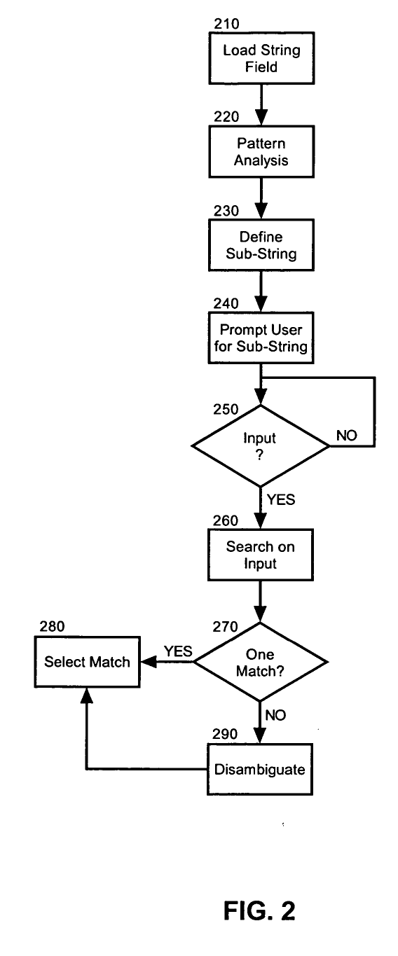

In more particular explanation of the disambiguation process, FIG. 2 is a flow chart illustrating a process for speech disambiguation of strings in the IVR system of FIG. 1. Beginning in block 210, a form field can be selected for processing and the possible entries for the form field can be loaded for analysis. For example, in the context of a database of records, each record having multiple fields, one of the fields can be selected for processing, and the data for the selected field for each record can be loaded for analysis. In block 220, the string data for the selected field for each record can be subjected to the pattern analysis of the present invention.

The pattern analysis can include processing for identifying individual character positions in the string data of the selected field which include alpha, numeric and alphanumeric characters having a high likelihood of speech recognition. In particular, it is known that certain characters such as the letters “A”, “V” and “O” and the numbers “0” and “8” demonstrate poor speech recognition, while the letters “W”, “Q”, “L” and “Y” and the numbers “2” and “9” demonstrate high speech recognition. Additionally, the individual character positions can be analyzed for uniqueness among the string data for the selected field. Where the same character or number, regardless of the likelihood of recognition, appears in multiple records, poor uniqueness can be concluded for that character position. In any event, in block 230 a sub-string pattern can be defined for the string. Preference can be given to a sub-string appearing at the beginning or end of the string.

In block 240, end users can be prompted to provide input for the sub-string when an attempt is made to access the selected field. For instance, the end users can be prompted to provide “the first three digits of your social security number”, or “the last four digits of your order number”. Once the end users have responded to the prompt in decision block 250, in block 260 the database can be searched for a matching string for the selected field. Importantly, the search can be based upon the sub-string input such that zero or more matching records can be located for the sub-string. If, in decision block 270 only one record is found to include a matching string for the field, in block 280 the string can be provided as input to the selected field.

In contrast, if in decision block 270 multiple records are located which include strings for the selected field which match the sub-string input, in block 290, additional disambiguation can be performed. Specifically, additional fields for the records can be inspected to locate fields most likely to be able to be used to disambiguate the selection. Once located, the end users can be prompted to provide additional disambiguating input for the located fields. For instance, where two or more customers are found to have the same last four digits of a customer number, the zip code field for the customers can be selected to further disambiguate the selection to identify a unique, matching record.

The following example can be illustrative of the disambiguation process when applied to the prompting of a customer for a tracking number for an order:

| Tracking Number | Last Name | Zip Code | Telephone | Address |
|---|---|---|---|---|
| HHJ123TUASZ5678 | Michelini | 33433 | 451-1234 | 211 Via |
| | | | | Lactea |
| AIX135TUAHI1234 | Jaiswal | 33487 | 862-2145 | 344 |
| | | | | Congress |
| | | | | Ave |
| EDS556H7JII1234 | Davis | 33434 | 974-4532 | 76 Atlantic |
| | | | | Street |
| O8P786GTDS51234 | Agapi | 33487 | 862-9551 | 1234 |
| | | | | Opaloka |
| | | | | Blvd. |

Pattern: AAANNNAAAAANNNN (where A=alphanumeric, N=digit)
Sub-String: Last four digits of Tracking Number (NNNN)
   Scenario 1
Prompt: “Please say the last four digits of your tracking number” . . . User: “5678”
Search database using “5678”
Prompt: “The order will be delivered to 211 Via Lactea in two days”
   Scenario 2
Prompt: “Please say the last four digits of your tracking number” . . . User: “1234”
Search database using “1234” . . . 3 Matches Found
Select Telephone as disambiguating field because of numerics and uniqueness
Prompt: “Please say your 7 digit telephone number” . . . User: “862-2145”
Prompt: “The order will be delivered to 344 Congress Ave in five days”

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method for processing string input for a field in an interactive voice response (IVR) system, the method comprising the steps of:
identifying a sub-string pattern of characters within acceptable input for the field which is known to enjoy a high likelihood of recognition;
prompting an interacting user for string input limited to said sub-string pattern;
matching received sub-string input conforming to said sub-string pattern with data which conforms to said acceptable input to locate the string input for the field; and,
completing the field with said matched data.

2. The method of claim 1, wherein said identifying step comprises the step of identifying a sub-string pattern of characters within acceptable input for the field which is known to enjoy both a high likelihood of recognition and a high level of uniqueness.

3. The method of claim 1, wherein said identifying step comprises the step of identifying a sub-string pattern of numeric, alphabetic and alphanumeric characters within acceptable input for the field which is known to enjoy a high likelihood of recognition;

4. The method of claim 1, wherein said matching step comprises the step of querying a database for all records which have a specified field which contains said received sub-string input.

5. The method of claim 1, further comprising the step of pre-specifying which characters have a high likelihood of recognition.

6. The method of claim 1, further comprising the step of pre-specifying a likelihood of recognition value for each of said characters.

7. The method of claim 1, further comprising the step of, if said matching step produces a set of matching data, each data item in said set matching said sub-string input, disambiguating a desired data item from other data items in said set.

8. The method of claim 7, wherein said disambiguating step comprises the steps of:
selecting an additional field for processing,
additionally prompting said interacting user for additional input for said additional field;
matching received additional input for said additional prompting with data which conforms to said acceptable input to locate the string input for the field.

9. An interactive voice response (IVR) system comprising:
at least one form comprising at least one field which can be completed using input received through the IVR system;
a sub-string analyzer coupled to the IVR system; and,
a search processor coupled both to the IVR system and a database of data configured for searching based upon sub-strings which match sub-string patterns produced by said sub-string analyzer;
wherein said at least one field is completed using data matched in said database with said search processor using sub-string input provided through the IVR system.

10. The system of claim 9, further comprising disambiguation logic.

11. The system of claim 9, wherein said sub-string analyzer comprises a pre-configuration of computed recognition likelihoods for individual characters for use in forming said sub-string patterns.

12. A machine readable storage having stored thereon a computer program for processing string input for a field in an interactive voice response (IVR) system, the computer program comprising a routine set of instructions which when executed by a machine cause the machine to perform the steps of:
identifying a sub-string pattern of characters within acceptable input for the field which is known to enjoy a high likelihood of recognition;
prompting an interacting user for string input limited to said sub-string pattern;
matching received sub-string input conforming to said sub-string pattern with data which conforms to said acceptable input to locate the string input for the field; and,
completing the field with said matched data.

13. The machine readable storage of claim 12, wherein said identifying step comprises the step of identifying a sub-string pattern of characters within acceptable input for the field which is known to enjoy both a high likelihood of recognition and a high level of uniqueness.

14. The machine readable storage of claim 12, wherein said identifying step comprises the step of identifying a sub-string pattern of numeric, alphabetic and alphanumeric characters within acceptable input for the field which is known to enjoy a high likelihood of recognition;

15. The machine readable storage of claim 12, wherein said matching step comprises the step of querying a database for all records which have a specified field which contains said received sub-string input.

16. The machine readable storage of claim 12, further comprising the step of pre-specifying which characters have a high likelihood of recognition.

17. The machine readable storage of claim 12, further comprising the step of pre-specifying a likelihood of recognition value for each of said characters.

18. The machine readable storage of claim 12, further comprising the step of, if said matching step produces a set of matching data, each data item in said set matching said sub-string input, disambiguating a desired data item from other data items in said set.

19. The machine readable storage of claim 18, wherein said disambiguating step comprises the steps of:
selecting an additional field for processing,
additionally prompting said interacting user for additional input for said additional field;
matching received additional input for said additional prompting with data which conforms to said acceptable input to locate the string input for the field.
